(19) United States
(12) Patent Application Publication
(10) Pub. No.: US 2022/0268389 A1
(43) Pub. Date: Aug. 25, 2022

(54) PRE-TIGHTENING FORCE REPAIRING METHOD, REPAIRING METHOD INVOLVING COMBINATION OF PRE-TIGHTENING FORCE AND CLAMP, AND REPAIRED PIPELINE

(71) Applicant: BEIJING SAFETECH PIPELINE CO., LTD., Beijing (CN)

(72) Inventors: Minxu LU, Beijing (CN); Yang YANG, Beijing (CN); Shiying HOU, Beijing (CN); Xiao TIAN, Beijing (CN); Rongzhao GAO, Beijing (CN)

(73) Assignee: BEIJING SAFETECH PIPELINE CO., LTD., Beijing (CN)

(21) Appl. No.: 17/753,080

(22) PCT Filed: Aug. 20, 2020
(86) PCT No.: PCT/CN2020/110121

§ 371 Date: Feb. 17, 2022

(30) Foreign Application Priority Data
Aug. 20, 2019 (CN) 201910767920.9

(51) Int. Cl. F16L 55/168; F16L 55/175

(52) U.S. Cl. CPC F16L 55/1686; F16L 55/18; F16L 55/175

(57) ABSTRACT

Disclosed are a pre-tightening force repairing method, a repairing method involving a combination of a pre-tightening force and a clamp, and a repaired pipeline. The repairing method includes: (a) fixing part of a fiber material to a pipeline; (b) applying a pre-tightening force to the fiber material, winding multiple layers of the fiber material around the pipeline under the pre-tightening force; (c) in the state of applying the pre-tightening force, completing the curing of the multi-layer fiber composite material; and (d) mounting a clamp outside a repairing part of the fiber composite material. The magnitude of the pre-tightening force is designed to overcome the situation whereby a fiber composite material layer comes unstuck from the pipeline due to the radial shrinkage of the pipeline caused by a decrease in internal pressure and/or the axial stretching of the pipeline after the pipeline, which is under pressure, is repaired.

### CROSS-REFERENCE TO RELATED APPLICATIONS

This application requires the priority of Chinese application CN201910767920.9 submitted to the China National Intellectual Property Administration on Aug. 20, 2019.

### TECHNICAL FIELD

The present invention relates to a method for repairing a pipeline with a pre-tightening force, a combined method for repairing a pipeline by a pre-tightening force and a repaired pipeline.

### BACKGROUND

Pipeline transportation is one of the five major transportation industries in the national economy, and the distance of pipeline transporting oil and gas is more than 50,000 kilometers at present. During the long-term service of these pipelines, due to formation pressure, soil corrosion, galvanic corrosion, external force damage, etc., accidents such as pipeline bursting and leakage occur frequently, affecting the normal transportation operation of the pipeline. Therefore, there is a need for a technique for repairing and reinforcing the pipeline without stopping the transportation.

In addition, there may be situations which needs to increase the safe operation pressure due to production requirement and increase the safety factor due to changes in regions. Under such circumstances, some of the pipelines need to be enhanced to meet the requirement of increasing operation pressure and safety factor.

There are foreign reports on the technology of repairing pipelines by injecting epoxy into a casing. For pipelines with corrosion defects in the pipe body, British Gas has reported a repair method of epoxy resin injection. The inner-injected epoxy resin tube shell is formed by connecting an upper shell and a lower shell to surround the damaged area, forming an annular space with the pipeline, sealing both ends of the annular space and injecting high-strength epoxy resin slurry.

However, the reinforcement technique of above-mentioned casing injection epoxy does not have a good enhancement effect on pipeline axial stress, for example when pipeline circumferential weld exists crack and there is larger corrosion defect of circumferential dimension, the axial bearing capacity of the pipeline is often greatly reduced. At this time, axial reinforcement is required, and this method cannot be satisfied.

In recent years, there are some reports on the use of carbon fiber composite materials for the reinforcement of external damage defects in metal pipes. The patent CN1853847 of Beijing Anke Pipeline Engineering Technology Co., Ltd. discloses a method of repairing and reinforcing welding seam defects with carbon fiber composite materials. In addition, Chinese patent CN1616546 “Carbon Fiber Composite Materials and Methods for Repairing and Reinforcing Defective Pipelines” discloses a material for repairing and reinforcing pipelines and a method for repairing and reinforcing pipelines. The material includes a multi-layer carbon fiber composite material impregnated or painted with a certain composition of viscose glue, which can achieve a good repair and reinforcement effect. Using this technology can not only repair and reinforce metal pipelines, but also achieve the purpose of improving operating pressure and allowable capacity. However, when the corrosion area and depth are large, this method has certain limitations in improving the bending resistance of the pipeline, while the epoxy injection technology of the casing has certain advantages in improving the bending resistance of the pipeline. In addition, for some characteristic pipe fittings, such as the fixed pier of the pipeline, due to the limitation of structural geometric characteristics, it is difficult to achieve the reinforcement effect with magnetic fiber reinforcement alone.

Under the general situation, namely the internal pressure situation, the hoop stress of the pipeline is 2 times of the axial stress. Therefore, the repair of the pipeline is generally based on limiting the circumferential deformation of the pipeline, supplemented by the axial repair, and the repair is only designed to resist internal pressure failure. The axial repair strength is only half of the hoop repair strength. However, in the presence of complex geological conditions or other external stresses, the axial stress of the pipeline is very large, and the circumferential weld defects and other circumferential defects pose a high threat to the safety of the pipeline. The current repair method is only designed to resist internal pressure failure, and the axial repair is insufficient, the axial stress of the pipeline cannot be well shared, and the circumferential weld defects and circumferential defects cannot be adequately protected.

In the existing pipeline reinforcing method with composite material, and the pipeline is often in a pressurized operation, that is, the repair is carried out under the operating pressure. After the composite material reinforcement layer wound and solidified under the operating pressure in the pipeline, when the operating pressure is greatly reduced or fluctuated, or the pipeline is subjected to large axial tensile deformation, the pipeline will experience a large radial shrinkage or fluctuation, which cause a reduction of the shear strength of the interface between the reinforcement layer and the pipeline, and will reduce the axial repair effect of the reinforcement layer on the pipeline, and cause a debonding of the reinforcement layer from the pipeline, which will cause the reinforcement layer to lose its axial reinforcement effect.

Therefore, the present application aims to the axial repair of circumferential weld defect and other circumferential defects by restoring the axial bearing capacity of the pipeline to the level of the intact pipeline, and avoids the effect of reducing the shear strength of the repair layer and the pipeline interface due to the greatly reduced internal pressure fluctuations. The present application proposes a method for repairing pipelines by applying pre-tightening force to fiber composite material.

### SUMMARY

The invention provides a method of repairing a pipeline defect with fiber composite material by applying a pre-tightening force to fiber composite material. The method can effectively share pipeline axial load, restore pipeline axial bearing capacity to intact pipeline level. Even when the pipeline is deformed, the fiber composite material can still maintain effective bonding with the pipeline and provide effective protection. When the operating pressure of the pipeline changes, the fiber composite material can adapt to the radial contraction or expansion of the pipeline caused by the pressure change of the pipeline, ensuring the bonding with the pipeline.

A method for repairing a portion of a pipeline, comprising the following steps: (a) fixing a part of a fiber material to the pipeline; (b) applying a pre-tightening force to the fiber material and winding multiple layers of fiber material around the pipeline under the action of the pre-tightening force to cover a portion of the pipeline that needs to be repaired, wherein when winding each layer of fiber material, the fiber material is impregnated or painted with a viscose glue to form multiple layers of fiber composite material; (c) curing the multiple layers of fiber composite material with the pre-tightening force applied, wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

Preferably, the step (a) comprises painting or impregnating the part of the fiber material with a viscose glue to fix the part to the pipeline.

Preferably, the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:

$${F}_{p r e} = \{ {F}_{p r e 1} , {F}_{p r e 2} , {F}_{p r e 3} , {F}_{p r e 1} + {F}_{p r e 2} , {F}_{p r e 2} + {F}_{p r e 3} , {F}_{p r e 1} + {F}_{p r e 3} , {F}_{p r e 1} + {F}_{p r e 2} + {F}_{p r e 3} \} \\ {F}_{p r e 1} \geq \frac{{P}_{repair} \cdot {D}_{p i p e}}{2 \cdot {t}_{p i p e} \cdot {E}_{p i p e}} \cdot {t}_{f i b e r} \cdot {b}_{width} \cdot {E}_{f i b e r} \cdot {f}_{safe 1} \\ {F}_{p r e 2} \geq \frac{{μ}_{p i p e} \cdot {σ}_{y i e l d}}{{E}_{p i p e}} \cdot {t}_{f i b e r} \cdot {b}_{w i d t h} \cdot {E}_{f i b e r} \cdot {f}_{s a f e 2} \\ {F}_{p r e 3} \geq {ε}_{tensile} \cdot {t}_{f i b e r} \cdot {b}_{width} \cdot {E}_{f i b e r} \cdot {f}_{safe 3}$$

wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

Preferably, f_{safe1}, f_{safe2}, f_{safe3} is 0.5.

Preferably, f_{safe1}, f_{safe2}, f_{safe3} is 1.

Preferably, the length of the part of the fiber material fixed to the pipeline in step (a) is selected such that the fiber material does not slip relative to the pipeline in step (b).

Preferably, the length of the part of the fiber material is calculated by the following equation:

$$L \geq \frac{{F}_{p r e}}{{b}_{width} \cdot {τ}_{inter face shear}}$$

wherein when a result calculated by above equation is less than or equal to π·Dₚᵢₚₑ, i.e., L≤π·Dₚᵢₚₑ, the calculated result is used as the length of the part of the fiber material in step (a),
wherein when a result calculated by above equation is above π·Dₚᵢₚₑ, i.e., L>π·Dₚᵢₚₑ, the length of the part of the fiber material in step (a) is calculated by the following equation:

$$L \geq \frac{{F}_{pre} - π \cdot {D}_{pipe} \cdot {b}_{width} \cdot {τ}_{interface shear}}{{b}_{width} \cdot {τ}_{interlayer shear}} + π \cdot {D}_{pipe}$$

wherein, τ_{interface shear} is the shear strength at the interface between the pipeline and the fiber material; τ_{interlayer shear} is the shear strength between two adjacent layers of fiber material; L is an initial length of fiber material fixed to the pipeline before the pre-tightening force is applied.

Preferably, the fiber material is a unidirectional fiber material, in step (b),

(b1) winding one or more layers of hoop fiber material under the action of the pre-tightening force while painting a surface of the hoop fiber material with a viscose glue, and then laying one or more layers of axial fiber material while painting a surface of the axial fiber material with the viscose glue, wherein the step (b1) is repeated several times until repairing operation is completed; Or,
(b2) laying one or more layers of axial fiber material while painting a surface of the axial fiber material with a viscose glue, and then winding one or more layers of hoop fiber material under the action of pre-tightening force while painting a surface of the hoop fiber material with a viscose glue, wherein the step (b2) is repeated several times until repairing operation is completed.

Preferably, the axial fiber material is a fiber material with a high elastic modulus to ensure an axial repair effect and the hoop fiber material is a fiber material with a low elastic modulus and/or a low single-layer thickness to reduce hoop pre-tightening force required for repairing.

Preferably, the hoop fiber material is glass fiber.

Preferably, the fiber material is a bidirectional fibrous material, and in step (b), multiple layers of bidirectional fiber material are wound continuously under the pre-tightening force, wherein when each layer of bidirectional fiber material is wound, a surface of the bidirectional fiber material is painted with a viscose glue to form multi layers of bidirectional fiber composite material.

Preferably, the bidirectional fiber material is designed to be woven from hoop fibers and axial fibers with different elastic modulus, and wherein the axial fibers have high elastic modulus to ensure the axial repair effect, and the hoop fiber have low elastic modulus and/or low single-layer thickness, so as to reduce hoop tensile force required to achieve a repair effect.

Preferably, the hoop fiber material is glass fiber.

Preferably, curing speed of the viscose glue used in step (a) is faster than that of the viscose glue used in step (b).

Preferably, the portion of the pipeline that needs to be repaired includes defects of the pipeline, which defects are located in a pipeline body, a straight weld, a spiral weld or a circumferential weld and comprise volume defects, plane defects, diffuse damage defects or geometric defects.

Preferably, the fiber material is selected from aramid fibers, polyethylene fibers, carbon fibers, glass fibers, basalt fibers, boron fibers, Kevlar fibers, silicon carbide fibers, alumina fibers, ceramic fibers and other fibers for repairing pipeline.

A method of repairing a pipeline with a pre-tightening force and a fixture, comprising the following steps: (a) fixing a part of a fiber material to the pipeline; (b) applying a pre-tightening force to the fiber material and winding multiple layers of fiber material around the pipeline under the action of the pre-tightening force to cover a portion of the pipeline that needs to be repaired, wherein when winding each layer of fiber material, the fiber material is impregnated or painted with a viscose glue to form multiple layers of fiber composite material; (c) mounting a fixture on the fiber composite material with pre-tightening force applied, and injecting a curable polymer into a gap formed between the fixture and the pipeline, wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

Preferably, step (a) comprises painting or impregnating the part of the fiber material with a viscose glue to fix the part to the pipeline.

Preferably, the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:

$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$

wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

Preferably, f_{safe1}, f_{safe2}, f_{safe3} is 0.5.

Preferably, f_{safe1}, f_{safe2}, f_{safe3} is 1.

Preferably, the length of the part of the fiber material fixed to the pipeline in step (a) is selected such that the fiber material does not slip relative to the pipeline in step (b).

Preferably, the length of the part of the fiber material is calculated by the following equation:

$$L \geq \frac{{F}_{pre}}{{b}_{width} \cdot {τ}_{interface shear}}$$

wherein when a result calculated by above equation is less than or equal to π·Dₚᵢₚₑ, i.e., L≤π·Dₚᵢₚₑ, the calculated result is used as the length of the part of the fiber material in step (a),
wherein when a result calculated by above equation is above π·Dₚᵢₚₑ, i.e., L>π·Dₚᵢₚₑ, the length of the part of the fiber material in step (a) is calculated by the following equation:

$$L \geq \frac{{F}_{pre} - π \cdot {D}_{pipe} \cdot {b}_{width} \cdot {τ}_{interface shear}}{{b}_{width} \cdot {τ}_{interlayer shear}} + π \cdot {D}_{pipe}$$

wherein, τ_{interface shear} is the shear strength at the interface between the pipeline and the fiber material; τ_{interlayer shear} is the shear strength between two adjacent layers of fiber material; L is an initial length of fiber material fixed to the pipeline before the pre-tightening force is applied.

Preferably, the fiber material is a unidirectional fiber material, in step (b),

(b1) winding one or more layers of hoop fiber material under the action of the pre-tightening force while painting a surface of the hoop fiber material with a viscose glue, and then laying one or more layers of axial fiber material while painting a surface of the axial fiber material with the viscose glue, wherein the step (b1) is repeated several times until repairing operation is completed; Or,
(b2) laying one or more layers of axial fiber material while painting a surface of the axial fiber material with a viscose glue, and then winding one or more layers of hoop fiber material under the action of pre-tightening force while painting a surface of the hoop fiber material with a viscose glue, wherein the step (b2) is repeated several times until repairing operation is completed.

Preferably, the fiber material is a bidirectional fibrous material, and in step (b), multiple layers of bidirectional fiber material are wound continuously under the pre-tightening force, wherein when each layer of bidirectional fiber material is wound, a surface of the bidirectional fiber material is painted with a viscose glue to form multi layers of bidirectional fiber composite material.

Preferably, the curable polymer is an epoxy resin.

A repaired pipeline comprising a pipe section to be repaired and multiple layers of fiber material wound around the pipe section, wherein the fiber material is painted or impregnated with a viscose glue to form a fiber composite material, and the fiber composite material is applied to the pipe section under the action of the pre-tightening force, wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

Preferably, the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:

$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$

wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

Preferably, f_{safe1}, f_{safe2}, f_{safe3} is 0.5.

Preferably, f_{safe1}, f_{safe2}, f_{safe3} is 1.

Preferably, the fiber material is a unidirectional fiber material, wherein one or more layers of hoop fibers and axial fibers are alternately wound around the pipe section to be repaired.

Preferably, the fiber material is a bidirectional fibrous material, wherein multiple layers of bidirectional fiber material are wound continuously on the pipe section to be repaired.

Preferably, the repaired pipe further comprises a fixture mounted around the fiber composite material, wherein there is a gap formed between the fixture and the pipe section coated with the fiber composite material and a curable polymer is injected into the gap.

Preferably, the fixture is composed of a plurality of parts, and the fixture is provided with one or more injection holes and one or more exhaust holes.

### DESCRIPTION OF DRAWINGS

The advantages and objects of the present invention can be better understood in the preferred embodiments of the present invention described in detail below in conjunction with the accompanying drawings. The figures are not drawn to scale in order to better show the relationship of the components in the figures.

FIG. 1 shows a flow chart of the method for repairing the defect of pipeline with fiber composite material according to the present invention.

FIG. 2 shows a flow chart of the method for repairing pipeline with a pre-tightening force and fixture according to the present invention.

FIG. 3 shows the pipeline according to the present invention and its defect.

FIG. 4 shows an exploded view of a repaired pipeline according to the present invention.

FIG. 5 shows a schematic diagram of the pipeline repaired according to the present invention.

### DETAILED EMBODIMENTS

Various embodiments according to the present invention will be described in detail with reference to the accompanying drawings. Here, it is to be noted that, in the drawings, the same reference numerals are assigned to components having substantially the same or similar structures and functions, and repeated descriptions about them will be omitted. The term “comprising A, B, C, etc. in sequence” only indicates the order in which the components A, B, C, etc. are included, and does not exclude the possibility of including other components between A and B and/or between B and C.

The accompanying drawing of this specification is a schematic diagram, which assists in explaining the concept of the present invention, and schematically represents the shape of each part and its mutual relationship.

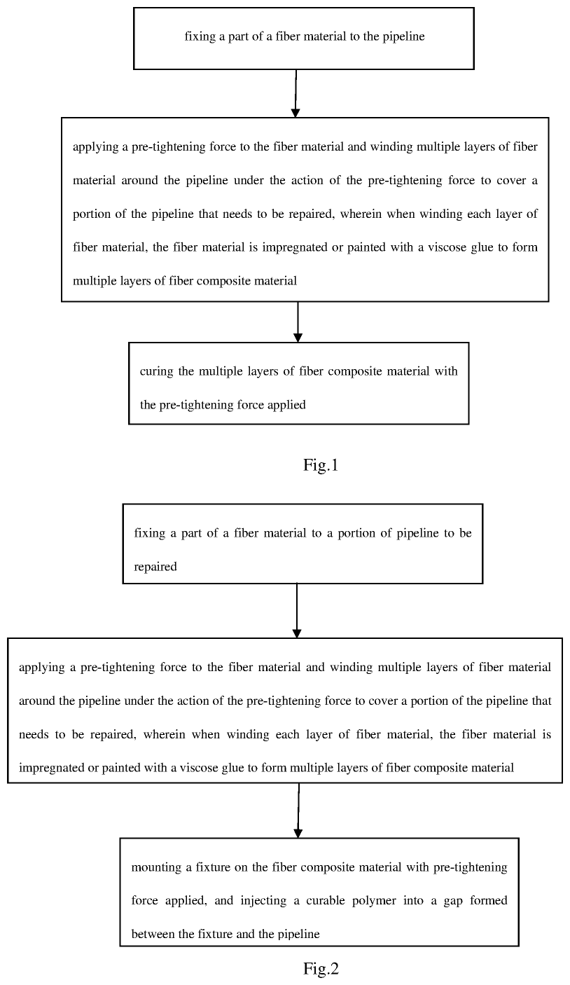

Below, with reference to FIG. 1, the preferred embodiment of the method according to the present invention is described in detail.

As shown in FIG. 1, the method for repairing a portion of a pipeline that needs to be repaired with fiber composite material comprises the following steps: (a) fixing a part of a fiber material to the pipeline; (b) applying a pre-tightening force to the fiber material and winding multiple layers of fiber material around the pipeline under the action of the pre-tightening force to cover the portion of the pipeline that needs to be repaired, wherein when winding each layer of fiber material, the fiber material is impregnated or painted with a viscose glue to form multiple layers of fiber composite material; (c) curing the multiple layers of fiber composite material with the pre-tightening force applied. The portion of the pipeline that needs to be repaired includes defects of the pipeline, which are located in a pipeline body, a straight weld, a spiral weld or a circumferential weld, etc. The defects of the pipeline include volume defects, plane defects, diffuse damage defects or geometric defects. The fiber material is selected from aramid fibers, polyethylene fibers, carbon fibers, glass fibers, basalt fibers, boron fibers, Kevlar fibers, silicon carbide fibers, alumina fibers and ceramic fibers. Different fibers have different elastic modulus, which lead to different applied pre-tightening forces in the field. The smaller the elastic modulus of the fiber material, the smaller the pre-tightening force applied to a single layer of fiber material, so it is easier to apply the pre-tightening force in the field. Taking carbon fiber, glass fiber, Kevlar fiber and basalt fiber as examples, the elastic modulus of the four fiber materials are shown in the following table:

| | Type of fiber | | | |
|---|---|---|---|---|
| | carbon | glass | Kevlar | basalt |
| | fiber | fiber | fiber | fiber |
| elastic modulus | 213 | 85 | 112 | 100 |
| (GPa) | | | | |

It can be seen that, the elastic modulus of the glass fiber is the smallest, so the pre-tightening force applied to the single layer of glass fiber is the smallest, which is more convenient to implement on site. Therefore, glass fiber is preferably used as the fiber composite material.

The amount of the pre-tightening force is designed to overcome the debonding of the layer of fiber composite material from the pipeline due to the radial shrinkage of the pipeline caused by the internal pressure drop or/and the axial stretching of the pipeline after the repair of a pressurized pipeline. Specifically, the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:

$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$

wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100, preferably greater than 0 and less than 50 and more preferably greater than 0 and less than 2.5, wherein the safety factor 0.5 indicates that the pressure in the pipeline drops to half of the pressure under repair and the safety factor 1 indicates that the pressure in the pipeline drops from the pressure under repair to 0; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

In step (a), the part of the fiber material is preferably painted or impregnated with a viscose glue and then fixed to the pipeline. It will be appreciated that other fixing means are possible as long as a part of the fiber material can be secured to the pipeline so as to apply the pre-tightening force.

The length of the part of the fiber material in step (a) is determined based on the pre-tightening force to ensure that the fiber material does not slip relative to the pipeline during the winding step (b).

The length can be determined empirically, or preferably, the length can be calculated by the following equation:

$$L \geq \frac{{F}_{pre}}{{b}_{width} \cdot {τ}_{interface shear}}$$

When the result calculated by above equation is less than or equal to π·Dₚᵢₚₑ, i.e., L≤π·Dₚᵢₚₑ, the calculated result is used as the length of the part of the fiber material in step (a).

When the result calculated by above equation is above π·Dₚᵢₚₑ, i.e., L>π·Dₚᵢₚₑ, the length of the part of the fiber material in step (a) is calculated by the following equation:

$$L \geq \frac{{F}_{pre} - π \cdot {D}_{pipe} \cdot {b}_{width} \cdot {τ}_{interface shear}}{{b}_{width} \cdot {τ}_{interlayer shear}} + π \cdot {D}_{pipe}$$

wherein, τ_{interface shear} is the shear strength at the interface between the pipeline and the fiber material; τ_{interlayer shear} is the shear strength between two adjacent layers of fiber material; L is an initial length of fiber material fixed to the pipeline before the pre-tightening force is applied.

The viscose glue in the step (a) may be a quick viscose glue to realize a quick fixing of the fiber material to the pipeline. The viscose glue is used for impregnating fiber materials, bonding between fiber materials and metal materials such as pipes, and bonding between fiber materials. The viscose glue used in step (a) is different from the viscose glue used in step (b), and advantageously the viscose glue used in step (a) cures faster than the viscose glue used in step (b). The viscose glue may be divided into two types: winter use and summer use. Winter use and summer use have slightly different formulations and can usually be achieved by adjusting the amount of curing accelerator. When the ambient temperature is lower, the amount of curing accelerator can be appropriately increased. Those of ordinary skill in the art can know how to adjust the amount of curing accelerator at a certain temperature according to common knowledge in the art or through simple experiments.

The viscose glue used to paint or impregnate the fiber material may be epoxy or unsaturated polyester based glues. Epoxy glue can be divided into single-component epoxy glue, two-component epoxy glue and multi-component epoxy glue and mainly includes pure epoxy resin glue and modified epoxy resin glue. Modified epoxy resin glue is, for example, phenolic-epoxy glue, nylon-epoxy glue, nitrile-epoxy glue, acrylic-epoxy glue, polysulfide-epoxy glue and polyurethane-epoxy glue, etc.

Preferably, the viscose glue is made up of a first component and a second component, and the ratio between the first and second components is (3-4): 1. The first component comprises:

(A): 68%-84% by weight of liquid epoxy resin;
(B): 10%-15% by weight of acrylate liquid rubber;
(C): 5%-15% by weight of fumed silica; and
(D): 1%-2% by weight of pigment.
The second component comprises:
(E): 70%-90% by weight of modified amine epoxy curing agent; and
(F): 10%-30% by weight of epoxy curing accelerator 2,4,6-tris(dimethylamino)-methylphenol.

The epoxy resin of the component (A) is bisphenol A type epoxy resin or vinyl modified epoxy resin. The curing agent of the component (E) is modified aliphatic amine.

The viscose glue can be prepared by mixing and storing the first and second components in which the first and second components are mixed with a stirrer after the first and second components are accurately weighed. The amount of the viscose glue prepared at one time should be able to be used up within the use time.

The method of the present invention also comprises, before step (a), cleaning the welding seam and the surface around the welding seam and painting repairing adhesive layer and/or primer layer on the surface after cleaning. The repairing adhesive layer and the primer layer are painted with epoxy glue.

The repairing glue used in the present invention is used for filling and repairing the damage defect outside the pipeline, and the use of the primer layer is helpful for the bonding between the fiber composite material and the pipeline body. Similar to the viscose glue, the repairing glue can be divided into two types: winter use and summer use. Those skilled in the art are familiar with the formulations of the repair adhesive and primer layer, so they will not be repeated here.

When the fiber material is a unidirectional fiber material including hoop fibers and axial fibers, in step (b), the hoop fibers and the axial fibers are alternately wound. That is to say, the hoop fiber material is wound under the action of pre-tightening force while the surface of the hoop fiber material is painted with viscose glue, and then the axial fiber material is laid while the viscose glue is applied to the surface of the axial fiber material. The above process is repeated many times until the repairing operation is completed. Or, the axial fiber material is laid while viscose glue is applied on the surface of the axial fiber material, and then the hoop fiber material is wound under the action of pre-tightening force while the hoop fiber material is painted with viscose glue. The above process is repeated several times until the repairing operation is completed.

Advantageously, the axial fiber material is a fiber material with high elastic modulus to ensure the axial repair effect and the hoop fiber material is a fiber material with low elastic modulus and/or low single-layer thickness to reduce circumferential construction tension value required to achieve pre-tensioning repair effect.

During repairing, the hoop fiber composite material is wound while applying a pre-tightening force, and under the action of the pre-tightening force, the hoop fiber composite material will produce tensile deformation. By controlling the amount of the pre-tightening force, the deformation amount of the composite material can be controlled. Specifically, the control of the deformation amount of the hoop fiber composite material should meet the following requirements: 1) when the internal pressure of the pipeline decreases from the service pressure, the radial deformation of the pipeline occurs and the diameter of the pipeline becomes smaller, the deformation amount of the composite material caused by the pre-tightening force should be greater than the deformation amount of the diameter caused by the pressure of the pipeline; and 2) in the case that the pipeline is subjected to axial stress and there is a yield in the axial direction, the deformation amount of the composite material caused by the pre-tightening force should be able to ensure the bonding between the composite material and the outer wall of the pipeline when the pipeline is at the yield point.

The control of the thickness and of the axial length of the axial fiber composite material should meet the following requirements: the axial length should ensure that the bonding force between the pipeline and the composite material is sufficient to bear the axial load of the pipeline, and the thickness should ensure that the deformation at the pipeline defects is limited.

When the fiber material is a bidirectional fiber material, winding the multi layers of fiber material comprises continuously winding the multi layers of the bidirectional fiber material under a pre-tightening force, and painting the surface of the bidirectional fiber material with a viscose glue while winding each layer of the bidirectional fiber material glue to form multi layers of bidirectional fiber composite material.

It should be understood that the present invention aims to the axial repair of the pipeline by restoring the axial bearing capacity of the pipeline to the level of the intact pipeline, instead of aiming to the axial repair according to half the number of layers in the conventional circumferential repair. This enables the axial repair of pipeline defects, especially circumferential weld defects and other circumferential defects, and not only restores the normal internal pressure bearing level, but also restores the axial bearing capacity to the level of intact pipelines, which is more suitable for complex geological conditions or other situations where axial external stress exists since geological changes are likely to cause additional large axial stress to the pipeline.

At the same time, the method of repairing pipeline by the fiber composite material with pre-tightening force keeps the composite material with a certain pre-tightening force during the repairing period and after curing. The pre-tightening force is calculated according to the force of tensile deformation of the composite material caused by the expansion of the pipeline body when the inner pressure in the pipeline increases from zero to the operating pressure, so that the repair under operation pressure can achieve the effect of repairing at zero internal pressure, so as to avoid the effect of reducing the shear strength of the repair layer and the pipeline interface due to the greatly reduced internal pressure fluctuations.

FIG. 2 shows a method for repairing a pipeline with a pre-tightening force and a fixture, comprising the steps of: (a) fixing a part of a fiber material to the pipeline; (b) applying a pre-tightening force to the fiber material and winding multiple layers of fiber material around the pipeline under the action of the pre-tightening force to cover a portion of the pipeline that needs to be repaired, wherein when winding each layer of fiber material, the fiber material is impregnated or painted with a viscose glue to form multiple layers of fiber composite material; (c) mounting a fixture on the fiber composite material with pre-tightening force, and injecting a curable polymer into the gap formed between the fixture and the pipeline, wherein the pre-tightening force is designed to overcome the debonding of the layer of fiber composite material from the pipeline due to the radial shrinkage of the pipeline caused by the internal pressure drop or/and the axial stretching of the pipeline after a pressurized pipeline is repaired.

The step (a) comprises painting or impregnating the part of the fiber material with a viscose glue and securing the portion to the pipeline.

Injecting the curable polymer into the gap formed between the fixture and the pipeline comprises: (1) preparing a fixture according to the shape and size of the pipeline, the fixture being composed of a plurality of parts, and the fixture comprising one or more injection holes and one or more exhaust holes; (2) mounting the plurality of parts of the fixture on the pipeline to be repaired; (3) connecting the various parts of the fixture by welding or bolting (4) tightly connecting the end of the fixture and the pipeline that needs to be repaired by welding or sealing with a sealing material, or by any combination thereof; (5) injecting the curable polymer into the gap formed between the fixture and the pipeline to be repaired through the one or more injection holes; and (6) curing the injected polymer.

The sealing material includes rubber, silica gel, curable resin, mastic, reinforcing steel or asbestos rope with good sealing performance, or any combination of at least two of them. Preferably, the sealing material is epoxy resin.

The injection hole and the exhaust hole are in opposite or generally opposite positions.

The curable polymers are selected from liquid rubbers, cellulose derivatives, vinyl polymers or copolymers thereof, saturated or unsaturated polyesters, polyacrylates, polyethers, polysulfones, aminoplasts, epoxy resins, phenolic resins, polyimide resins, amino resins, unsaturated polyester resins, or modifications of any of the above.

The elastic modulus of the curable polymer is greater than 0.1 GPa, preferably greater than 1 GPa, more preferably greater than 2 GPa, and the compressive strength is greater than 10 MPa, preferably greater than 20 MPa, more preferably greater than 50 MPa.

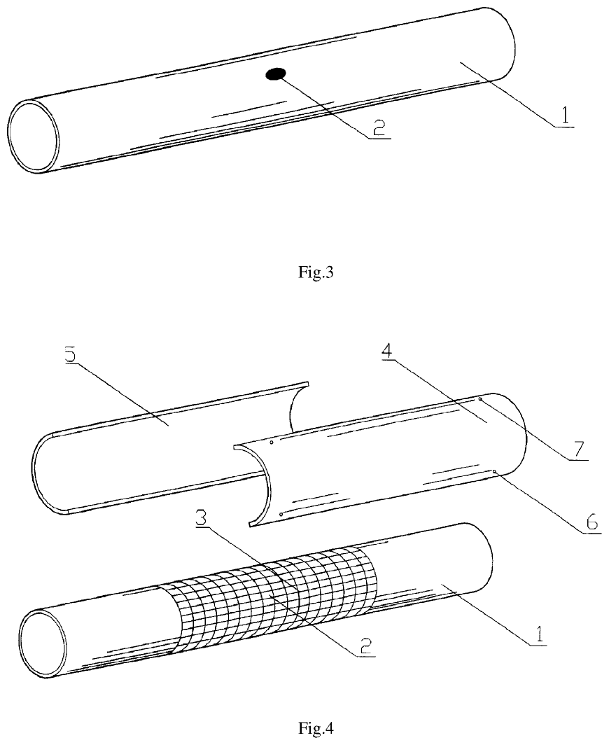

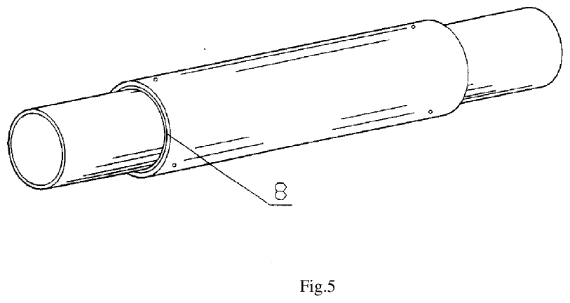

Next, a schematic diagram of a repaired pipeline according to the present invention is described with reference to FIGS. 3 to 5.

The repaired pipeline comprises a pipe section 1 with a defect 2 and multiple layers of fiber composite material 3 wound around the pipe section 1. The fiber composite material is painted or impregnated with a viscose glue. The fiber composite material is applied with a pre-tightening force which is designed to overcome the debonding of the layer of fiber composite material from the pipeline due to the radial shrinkage of the pipeline caused by the internal pressure drop or/and the axial stretching of the pipeline after the repair of a pressurized pipeline.

The fiber material may be a unidirectional fiber material including hoop fibers and axial fibers. The hoop fibers and the axial fibers are alternately wound. That is to say, the hoop fiber material is wound under the action of pre-tightening force while the surface of the hoop fiber material is painted with viscose glue, and then the axial fiber material is laid while the viscose glue is applied to the surface of the axial fiber material. The above process is repeated many times until the repairing operation is completed. Or, the axial fiber material is laid while viscose glue is applied on the surface of the axial fiber material, and then the hoop fiber material is wound under the action of pre-tightening force while the hoop fiber material is painted with viscose glue. The above process is repeated several times until the repairing operation is completed.

The fiber material may be a bidirectional fiber material which is wound around the pipe section with defects continuously to form bidirectional fiber composite material.

The repaired pipeline also includes a fixture which is made up of two parts, namely the first half fixture 4 and the second half fixture 5. It should be understood that the fixture can also be composed of more than two parts, as long as the purpose of the present invention can be achieved. The fixture are made according to the shape and size of the pipeline, which is similar in shape to the pipeline but larger in size to create a gap between the fixture and the pipeline to inject the curable polymer. The fixture is provided with one or more injection holes 6 and one or more exhaust holes 7. After the fixture is installed on the fiber composite material, a sealing material 8 is applied between the fixture and the pipeline.

The axial bearing capacity of the repaired pipeline of the present invention can be restored to the level of the intact pipeline, which is more suitable for complex geological conditions or the existence of other axial external stresses which the geological changes may cause extra large axial stress to the pipeline. At the same time, by the fiber composite material with a pre-tightening force, the pipeline can be repaired at operation pressure, achieving a repair effect at zero internal pressure, so as to avoid the decrease of the shear strength at the interface between the repair layer and the pipeline due to the fluctuation of the internal pressure.

The above description is only an explanation of the present invention, so that those of ordinary skill in the art can completely implement the present scheme, but are not intended to limit the present invention. The technical features disclosed above are not limited to the disclosed combination with other features, and those skilled in the art can also perform other combinations between the technical features according to the purpose of the invention, so as to achieve the purpose of the present invention.

1. A method for repairing a portion of a pipeline, comprising the following steps:
(a) fixing a part of a fiber material to the pipeline;
(b) applying a pre-tightening force to the fiber material and winding multiple layers of fiber material around the pipeline under the action of the pre-tightening force to cover a portion of the pipeline that needs to be repaired, wherein when winding each layer of fiber material, the fiber material is impregnated or painted with a viscose glue to form multiple layers of fiber composite material;
(c) curing the multiple layers of fiber composite material with the pre-tightening force applied,
wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

2. The method of claim 1, wherein step (a) comprises painting or impregnating the part of the fiber material with a viscose glue to fix the part to the pipeline.

3. The method of claim 2, wherein the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:
$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$
wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

4-5. (canceled)

6. The method of claim 1, wherein the length of the part of the fiber material fixed to the pipeline in step (a) is selected such that the fiber material does not slip relative to the pipeline in step (b).

7. The method of claim 6, wherein the length of the part of the fiber material is calculated by the following equation:
$$L \geq \frac{{F}_{pre}}{{b}_{width} \cdot {τ}_{interface shear}}$$
wherein when a result calculated by above equation is less than or equal to π·Dₚᵢₚₑ, i.e., L≤π·Dₚᵢₚₑ, the calculated result is used as the length of the part of the fiber material in step (a), wherein when a result calculated by above equation is above π·Dₚᵢₚₑ, i.e., L>π·Dₚᵢₚₑ, the length of the part of the fiber material in step (a) is calculated by the following equation:
$$L \geq \frac{{F}_{pre} - π \cdot {D}_{pipe} \cdot {b}_{width} \cdot {τ}_{interface shear}}{{b}_{width} \cdot {τ}_{interlayer shear}} + π \cdot {D}_{pipe}$$
wherein, τ_{interface shear} is the shear strength at the interface between the pipeline and the fiber material; τ_{interlayer shear} is the shear strength between two adjacent layers of fiber material; L is an initial length of fiber material fixed to the pipeline before the pre-tightening force is applied.

8. The method of claim 1, wherein the fiber material is a unidirectional fiber material, in step (b),
(b1) winding one or more layers of hoop fiber material under the action of the pre-tightening force while painting a surface of the hoop fiber material with a viscose glue, and then laying one or more layers of axial fiber material while painting a surface of the axial fiber material with the viscose glue, wherein the step (b1) is repeated several times until repairing operation is completed; Or,
(b2) laying one or more layers of axial fiber material while painting a surface of the axial fiber material with a viscose glue, and then winding one or more layers of hoop fiber material under the action of pre-tightening force while painting a surface of the hoop fiber material with a viscose glue, wherein the step (b2) is repeated several times until repairing operation is completed.

9. The method according to claim 8, wherein the axial fiber material is a fiber material with a high elastic modulus to ensure an axial repair effect and the hoop fiber material is a fiber material with a low elastic modulus and/or a low single-layer thickness to reduce hoop pre-tightening force required for repairing.

10. (canceled)

11. The method of claim 1, wherein the fiber material is a bidirectional fibrous material, and in step (b), multiple layers of bidirectional fiber material are wound continuously under the pre-tightening force, wherein when each layer of bidirectional fiber material is wound, a surface of the bidirectional fiber material is painted with a viscose glue to form multi layers of bidirectional fiber composite material.

12. The method of claim 11, wherein the bidirectional fiber material is designed to be woven from hoop fibers and axial fibers with different elastic modulus, and wherein the axial fibers have high elastic modulus to ensure the axial repair effect, and the hoop fiber have low elastic modulus and/or low single-layer thickness, so as to reduce hoop tensile force required to achieve a repair effect.

13-16. (canceled)

17. A method of repairing a pipeline with a pre-tightening force and a fixture, comprising the following steps:
(a) fixing a part of a fiber material to the pipeline;
(b) applying a pre-tightening force to the fiber material and winding multiple layers of fiber material around the pipeline under the action of the pre-tightening force to cover a portion of the pipeline that needs to be repaired, wherein when winding each layer of fiber material, the fiber material is impregnated or painted with a viscose glue to form multiple layers of fiber composite material;
(c) mounting a fixture on the fiber composite material with pre-tightening force applied, and injecting a curable polymer into a gap formed between the fixture and the pipeline,
wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

18. (canceled)

19. The method of claim 17, wherein the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:
$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$
wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

20-21. (canceled)

22. The method of claim 17, wherein the length of the part of the fiber material fixed to the pipeline in step (a) is selected such that the fiber material does not slip relative to the pipeline in step (b).

23. The method of claim 22, wherein the length of the part of the fiber material is calculated by the following equation:
$$L \geq \frac{{F}_{pre}}{{b}_{width} \cdot {τ}_{interface shear}}$$
wherein when a result calculated by above equation is less than or equal to π·Dₚᵢₚₑ, i.e., L≤π·Dₚᵢₚₑ, the calculated result is used as the length of the part of the fiber material in step (a), wherein when a result calculated by above equation is above π·Dₚᵢₚₑ, i.e., L>π·Dₚᵢₚₑ, the length of the part of the fiber material in step (a) is calculated by the following equation:
$$L \geq \frac{{F}_{pre} - π \cdot {D}_{pipe} \cdot {b}_{width} \cdot {τ}_{interface shear}}{{b}_{width} \cdot {τ}_{interlayer shear}} + π \cdot {D}_{pipe}$$
wherein, τ_{interface shear} is the shear strength at the interface between the pipeline and the fiber material; τ_{interlayer shear} is the shear strength between two adjacent layers of fiber material; L is an initial length of fiber material fixed to the pipeline before the pre-tightening force is applied.

24. The method of claim 17, wherein the fiber material is a unidirectional fiber material, in step (b),
(b1) winding one or more layers of hoop fiber material under the action of the pre-tightening force while painting a surface of the hoop fiber material with a viscose glue, and then laying one or more layers of axial fiber material while painting a surface of the axial fiber material with the viscose glue, wherein the step (b1) is repeated several times until repairing operation is completed; Or,
(b2) laying one or more layers of axial fiber material while painting a surface of the axial fiber material with a viscose glue, and then winding one or more layers of hoop fiber material under the action of pre-tightening force while painting a surface of the hoop fiber material with a viscose glue, wherein the step (b2) is repeated several times until repairing operation is completed.

25. The method of claim 17, wherein the fiber material is a bidirectional fibrous material, and in step (b), multiple layers of bidirectional fiber material are wound continuously under the pre-tightening force, wherein when each layer of bidirectional fiber material is wound, a surface of the bidirectional fiber material is painted with a viscose glue to form multi layers of bidirectional fiber composite material.

26. (canceled)

27. A repaired pipeline comprising a pipe section to be repaired and multiple layers of fiber material wound around the pipe section, wherein the fiber material is painted or impregnated with a viscose glue to form a fiber composite material, and the fiber composite material is applied to the pipe section under the action of the pre-tightening force, wherein the pre-tightening force is designed to overcome debonding of the layer of fiber composite material from the pipeline due to a radial shrinkage of the pipeline caused by an internal pressure drop and/or an axial stretching of the pipeline after a pressurized pipeline is repaired.

28. The repaired pipeline of claim 27, wherein the pre-tightening force Fₚᵣₑ is selected as one of Fₚᵣₑ₁, Fₚᵣₑ₂ and Fₚᵣₑ₃, the sum of any two of Fₚᵣₑ₁, Fₚᵣₑ₂ and Fₚᵣₑ₃ and the sum of Fₚᵣₑ₁, Fₚᵣₑ₂ and Fₚᵣₑ₃, wherein:
$${F}_{pre} = \{ {F}_{pre 1} , {F}_{pre 2} , {F}_{pre 3} , {F}_{pre 1} + {F}_{pre 2} , {F}_{pre 2} + {F}_{pre 3} , {F}_{pre 1} + {F}_{pre 3} , {F}_{pre 1} + {F}_{pre 2} + {F}_{pre 3} \} \\ {F}_{pre 1} \geq \frac{{P}_{repair} \cdot {D}_{pipe}}{2 \cdot {t}_{pipe} \cdot {E}_{pipe}} \cdot {t}_{fiber} \cdot {b}_{width} \cdot {E}_{fiber} \cdot {f}_{safe 1} \\ {F}_{pre 2} \geq \frac{{μ}_{pipe} \cdot {σ}_{yield}}{{E}_{pipe}} \cdot {t}_{fiber} \cdot {b}_{width} \cdot {E}_{fiber} \cdot {f}_{safe 2} \\ {F}_{pre 3} \geq {ε}_{tensile} \cdot {t}_{fiber} \cdot {b}_{width} \cdot {E}_{fiber} \cdot {f}_{safe 3}$$
wherein, Pᵣₑₚₐᵢᵣ is the pressure of the pipeline under repair; Dₚᵢₚₑ is the outer diameter of the pipeline; tₚᵢₚₑ is the wall thickness of the pipeline; f_{safe1}, f_{safe2}, f_{safe3} is a safety factor which is greater than 0 and less than 100; t_{fiber} is the theoretical thickness of a single layer of fiber material; b_{width} is the width of the fiber material; E_{fiber} is the elastic modulus of the fiber material; Eₚᵢₚₑ is the elastic modulus of the pipeline material; μₚᵢₚₑ is the poisson's ratio of the pipeline material; σ_{yield} is the yield strength of the pipeline material; εₜₑₙₛᵢₗₑ is the circumferential plastic strain of the pipeline when the axial load of the pipeline is the tensile strength; Fₚᵣₑ₁ is a pre-tightening force that overcomes the debonding of the layer of fiber composite material from the pipeline due to the radial shrinkage of the pipeline caused by the internal pressure drop of the pipeline after the repair of a pressurized pipeline; Fₚᵣₑ₂ is a pre-tightening force that overcomes the debonding of the layer of fiber composite material from the pipeline due to the radial shrinkage of the pipeline caused by the axial tensile elastic strain of the pipeline after the repair of a pressurized pipeline; Fₚᵣₑ₃ is a pre-tightening force that overcomes the debonding of the layer of fiber composite material from the pipeline due to the radial shrinkage of the pipeline caused by the axial tensile plastic strain of the pipeline after the repair of a pressurized pipeline; Fₚᵣₑ is a pre-tightening force that is applied to the single layer of fiber material.

29-30. (canceled)

31. The repaired pipeline of claim 27, wherein the fiber material is a unidirectional fiber material, wherein one or more layers of hoop fibers and axial fibers are alternately wound around the pipe section to be repaired.

32. The repaired pipeline of claim 27, wherein the fiber material is a bidirectional fibrous material, wherein multiple layers of bidirectional fiber material are wound continuously on the pipe section to be repaired.

33. The repaired pipeline of claim 27, wherein the repaired pipe further comprises a fixture mounted around the fiber composite material, wherein there is a gap formed between the fixture and the pipe section coated with the fiber composite material and a curable polymer is injected into the gap, wherein, the fixture is composed of a plurality of parts, and the fixture is provided with one or more injection holes and one or more exhaust holes.

34. (canceled)
